(19) United States
(12) Patent Application Publication
(10) Pub. No.: US 2010/0194790 A1
(43) Pub. Date: Aug. 5, 2010

(54) Set of light emissive diode elements for a backlight device and backlight display

(76) Inventors: Gerard Rilly, Saint Etienne Crossey (FR); Gerard Morizot, Voiron (FR); Philippe Le Roy, Betton (FR)

Correspondence Address: Robert D. Shedd, Patent Operations;THOMSON Licensing LLC, P.O. Box 5312, Princeton, NJ, 08543-5312, US

(21) Appl. No.: 12/311,300

(22) PCT Filed: Sep. 19, 2007
(86) PCT No.: PCT/EP2007/059912

§ 371 Date: Mar. 3, 2010

(30) Foreign Application Priority Data
Sep. 26, 2006 (FR) 0653938

(51) Int. Cl. G09G 5/10

(52) U.S. Cl. 345/691

(57) ABSTRACT

The invention relates to a backlight device with light emissive diodes not requiring the supply of a large current. According to the invention, each light emissive diode of the backlight device is combined with a voltage converter capable of storing energy during part of the operating cycle and then discharging this energy into the light emissive diode during another part of the cycle.

### FIELD OF THE INVENTION

The present invention is situated in the field of backlight devices for all types of backlight displays or projectors, such as liquid crystal displays or any type of backlight panel such as advertising panels.

### Technological Background

Such displays or projectors equipped with discharge lamps are known for being relatively difficult to control in intensity and colorimetry. The notable advances made in light emissive diodes enable new types of backlight devices to be realized. The backlight device thus comprises a plurality of light emissive diodes or LEDs organised in an array form. These diodes are possibly grouped into basic blocks and are thus controlled per block instead of being individually controlled. These diodes are preferably controlled dynamically to improve the contrast and appearance of the display movements.

Each diode operates at a low voltage in the order of 2 to 5 volts. This low control voltage constitutes a disadvantage as, when for example the power consumed by the diodes must be 100 watts and this power operates at 2 volts, the necessary current is then 50 Amperes.

### SUMMARY OF THE INVENTION

One purpose of the invention is to propose a new type of backlight device not requiring the supply of such a high current.

According to the invention, it is proposed to combine with each light emissive diode a voltage converter capable of storing energy during part of the operating cycle and then discharging this energy into the light emissive diode during another part of the cycle.

The present invention relates to a set of light emissive diode elements for backlighting, wherein each element comprises a light emissive diode and wherein at least one element is equipped with a step-down voltage converter circuit to supply the light emissive diode.

According to one particular embodiment, the voltage converter circuit comprises an inductive element and a switch, the switch being controlled such that the inductive element stores energy during a first operating phase and discharges this energy into the light emissive diode during a second operating phase consecutive to the first operating phase.

The invention also relates to a backlight device for displays, such as for instance a liquid crystal display, comprising:
a set of light emissive diode elements organised in rows and columns, each element comprising a light emissive diode and at least one element equipped with a step-down voltage converter to supply the said light emissive diode, and
a control circuit to control the voltage converter circuit of the said one light emissive diode.

According to one particular embodiment, the voltage converter circuit comprises an inductive element and a switch, the switch being controlled such that the inductive element stores energy during a first operating phase and discharges this energy into the light emissive diode during a second operating phase consecutive to the first operating phase.

In practice, the light emissive diode elements of the set are organised into rows and columns and the control circuit comprises a selection circuit to sequentially select the rows of elements of the set, and a control circuit to trigger and control the time of the first operating phase of the elements of the row selected by the said selection circuit.

Preferably, the light emissive diodes are arranged into basic blocks, each basic block comprising at least one light emissive diode element, and the elements of a same block thus being controlled in the same manner. In this case, the selection circuit of the device selects sequentially rows of basic blocks and the control circuit triggers and controls the time of the first operating phase of the blocks selected by the selection circuit.

From a functional viewpoint, the first operating phases of the elements of two basic blocks belonging respectively to one row of current blocks and one row of next blocks are not covering. For each element, the time of the first operating phase is variable. It is comprised between a minimum time and a maximum time.

Advantageously, the first operating phase of the blocks of the next row begins at the end of a period equal to the maximum time after the start of the first operating phase of the blocks of the current row.

The invention also relates to a display comprising a backlight device to produce light and an imaging device lit by the light produced by the backlight device to display an image during a video frame. The backlight device of this display is in accordance with the backlight device defined previously.

Advantageously, the operating period of the backlight device is synchronised with the video frame period of the display. The video frame period is for example a multiple of the time of the operating period of the backlight device. The time of the operating period of the backlight device is preferably less than 50 μs (frequency greater than or equal to 20 kHz) so that the operation is inaudible to the human ear.

### DESCRIPTION OF THE FIGURES

The invention will be better understood upon reading the following description, provided as a non-restrictive example and referring to the annexed drawings wherein:

FIG. 1 shows a backlight device in accordance with the invention,

FIG. 2 is a detailed diagram of a basic block of light emissive diode elements of the basic block array of the device of FIG. 1,

FIG. 3 is a first example of a circuit diagram of a light emissive diode element of the block of FIG. 2,

FIG. 4 is a first example of a circuit diagram of an AND type logic gate of the element of FIG. 3,

FIG. 5 is a second example of a circuit diagram of an AND type logic gate of the element of FIG. 3,

FIG. 6 shows timing diagrams illustrating a first operating mode of the light emissive diode element of FIG. 3,

FIG. 7 shows timing diagrams illustrating the sequential lighting of the basic block array of the backlight device of FIG. 1,

FIG. 8 shows the timing diagrams illustrating the input and output signals of the logic gate of FIG. 4 or 5,

FIG. 9 shows timing diagrams illustrating a second operating mode of the light emissive diode element of FIG. 3,

FIG. 10 is a second example of a circuit diagram of a light emissive diode element of the block of FIG. 2, and

FIG. 11 shows timing diagrams illustrating an operating mode of the light emissive diode element of FIG. 10,

### DESCRIPTION OF EMBODIMENTS

According to the invention, each diode element of the element array comprises, besides a light emissive diode, a step-down voltage converter to supply the diode and more particularly to store the energy during a first operating phase and discharge it into the diode during a second operating phase.

FIG. 1 shows a backlight device for displays that is in accordance with the invention. It comprises:
a set of 10 light emissive diode elements grouped into basic blocks 20, said basic blocks being organised into an array of n rows and m columns; each basic block comprising at least one light emissive diode element; the elements themselves are organised into arrays within the basic blocks; in this embodiment, the blocks are identical in size although this is not mandatory; the light emitted by each of these elements is time modulated; the elements are therefore controlled in PWM mode (Pulse Width Modulation)
a row selection circuit 11 to sequentially select the rows of basic blocks of the set 10; for a set 10 comprising n rows of basic blocks, the selection circuit 11 comprises n outputs, each output being designed to select a row of blocks of the set 10; in the rest of the description, Si designates the output intended to select the row i of blocks of the array 10,
a control circuit 12, to supply each column of blocks of the set 10, with a control signal for lighting the elements of the basic block located at the point crossed by the column and a row selected by the selection circuit 11; the control circuit 12 comprises m outputs, each output being connected to the basic blocks of the set 10; in the rest of the description, Cj designates the output connected to the column j of the set 10.

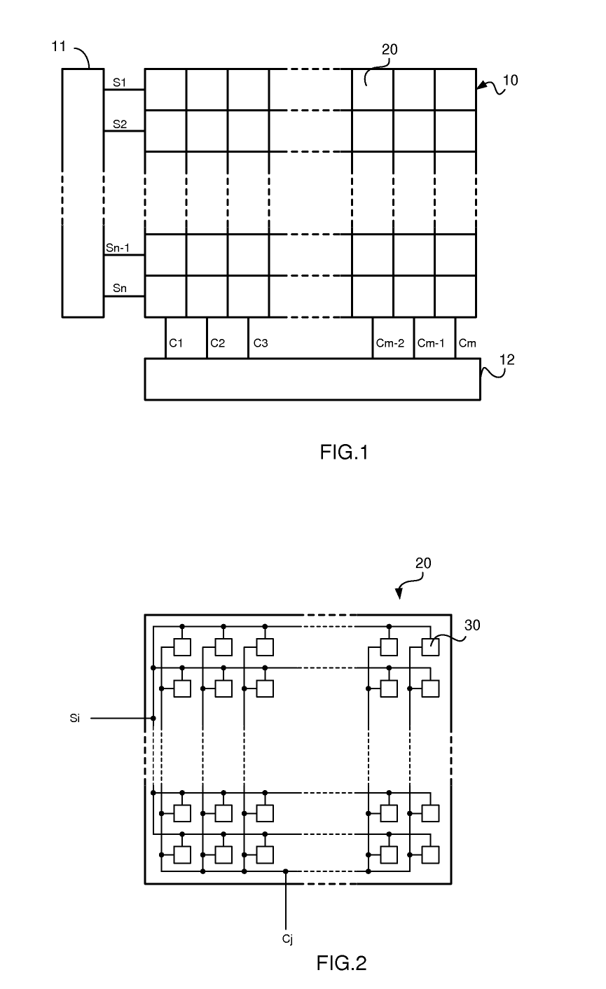

FIG. 2 shows the detailed diagram of a basic block 20 comprising an array of n′×m′ light emissive diode elements 30. Said basic block belongs to the row i and the column j of the set 10. Each of the elements 30 of the block 20 is therefore connected to the output Si of the selection circuit 11 and the output Cj of the control circuit 12.

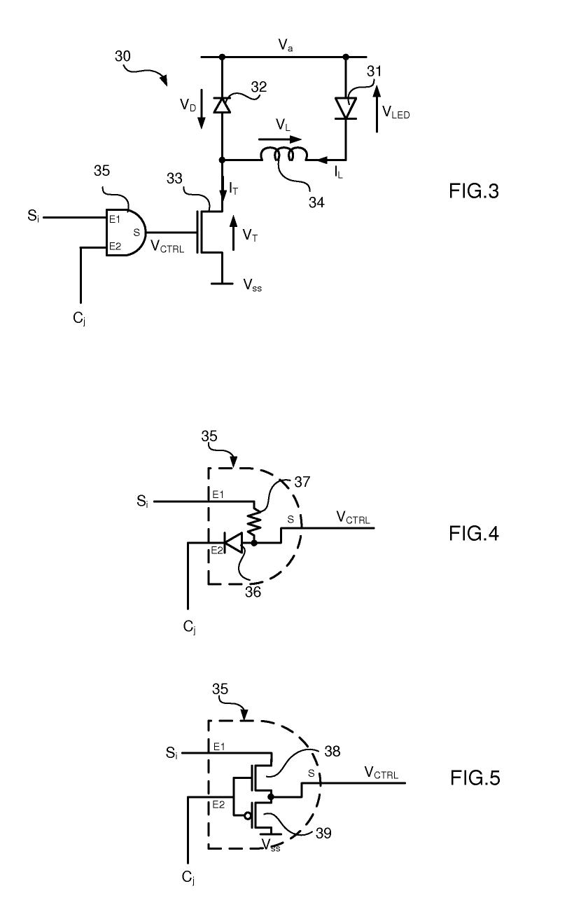

FIG. 3 shows a circuit diagram of a first example of a light emissive diode element 30. It comprises a light emissive diode or LED 31 and a step-down voltage converter to supply the LED. This converter comprises a diode 32 fitted in series with a switch 33 of the transistor type between a supply terminal receiving a supply voltage Va (known as the supply terminal) and a terminal receiving a voltage Vss. The latter terminal is for example connected to ground. Transistor 33 is controlled by a control voltage supplied by the output S of an AND logic gate 35, the said gate receives on a first input E1 a voltage signal coming from the output Si of the selection circuit 11 and on a second input E2 a voltage signal coming from the output Cj of the control circuit 12. The diode 32 is arranged to pass the current moving toward the supply terminal. The point located between the diode 32 and the transistor 33 is connected to the cathode of the LED 31 via an inductive element 34. The anode of LED 31 is connected to the supply terminal. In the rest of the description, L designates the inductance of the inductive element 34, V_{LED} designates the voltage at the terminals of the LED 31, V_{L} and I_{L} respectively designate the voltage at the terminals of the inductive element 34 and the current moving toward the inductive element 34, V_{D} designates the voltage at the terminals of the diode 32, V_{T} and I_{T} respectively designate the voltage at the terminals of the switch 33 and the current circulating in the switch 33 and V_{CTRL} designates the control voltage of the switch 33 present at the output of the gate 35.

A first circuit diagram example of the logic gate 35 is provided in FIG. 4. This gate comprises a diode 36 and a resistive element 37. The diode 36 is connected between the input E2 and the output S of the gate. The diode 36 is arranged to pass the current moving toward the input E2. The resistive element 37 is connected between the output S and the input E1.

A second circuit diagram example of the logic gate 35 provided in FIG. 5. This gate is a “push-pull” assembly comprising a transistor 38 of the NMOS type in series with a transistor 39 of the PMOS type. The common output (sources) of both transistors constitutes the output S of the logic gate 35. The input E2 is connected to the two gates of the transistors and the input E1 is connected to the drain of the transistor 38. Finally, the drain of the transistor 39 receives the Vss voltage.

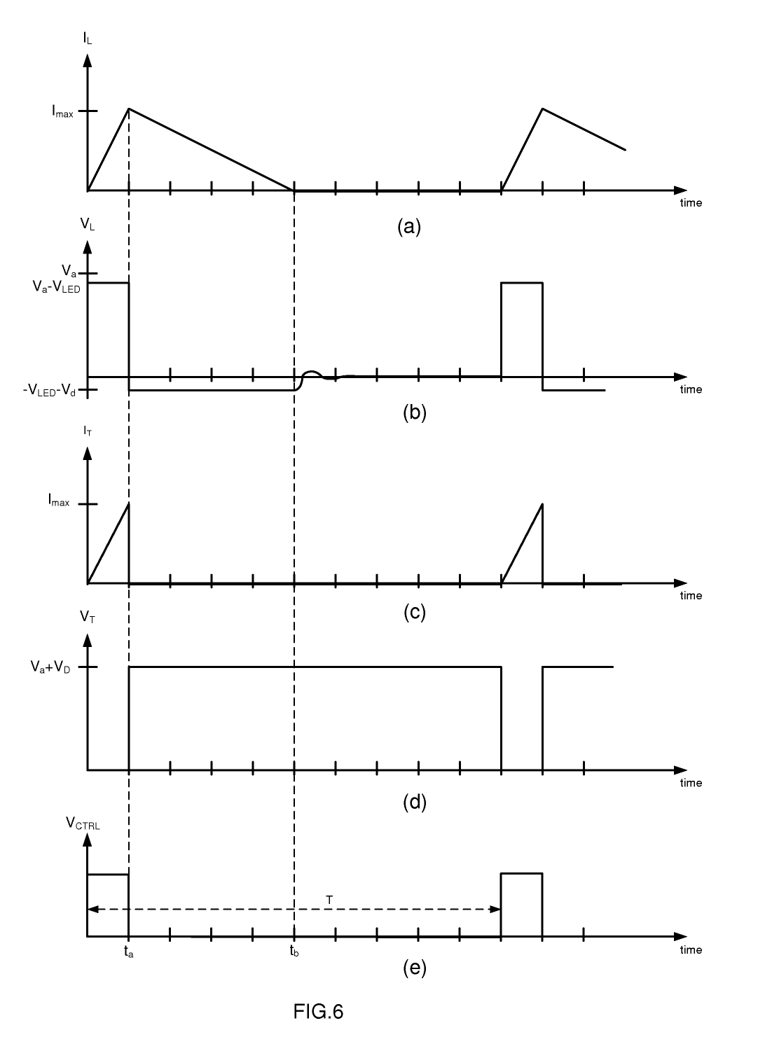

A first operating mode of this light emissive diode element is explained in the timing diagrams of FIG. 6. In this operating mode, the inductive element is completely discharged at each operating period. FIGS. 6(a), 6(b), 6(c), 6(d) and 6(e) respectively show the variation in the current I_{L}, the voltage V_{L}, the current I_{T}, the voltage V_{T} and the voltage V_{CTRL} during a period of time T of the control voltage V_{CTRL}.

In the timing diagrams, it is considered that the control voltage V_{CTRL} is at a high level between the times 0 and tₐ and at a low level (zero) between the times tₐ and T. The switch 33 is therefore closed (voltage V_{T} zero) between the times 0 and tₐ and open (voltage V_{T}=Vₐ₊V_{D}) between the times tₐ and T. The voltage V_{L} at the terminal of the inductive element 34 is therefore equal to Vₐ−V_{LED} between the times 0 and tₐ. A current I_{L} flows through the element 34, said current increasing in a linear manner until a maximum value Iₘₐₓ equal to

$$\frac{1}{2} \cdot \frac{( {V}_{a} - {V}_{LED} )}{L} {t}_{a}$$

at the time tₐ is reached. The current I_{T} flowing through the switch 33 is therefore equal to the current I_{L} flowing through the inductive element 34. When the switch 33 is open (between the times tₐ and T), the voltage V_{L} applied at the terminals of the inductive element 34 is equal to −V_{LED}−V_{D} until said inductive element is completely discharged. The discharge operation is complete at time t_{b}. The discharge current of the element 34 thus decreases until a zero value is reached at time t_{b}. When the inductive element 34 is completely discharged, the voltage V_{L} at its terminals becomes zero after a few oscillations due to a resonance between the inductive element 34 and the interference capacitors of the elements 32, 33 and 34. The same operating cycle starts again at the end of the time T.

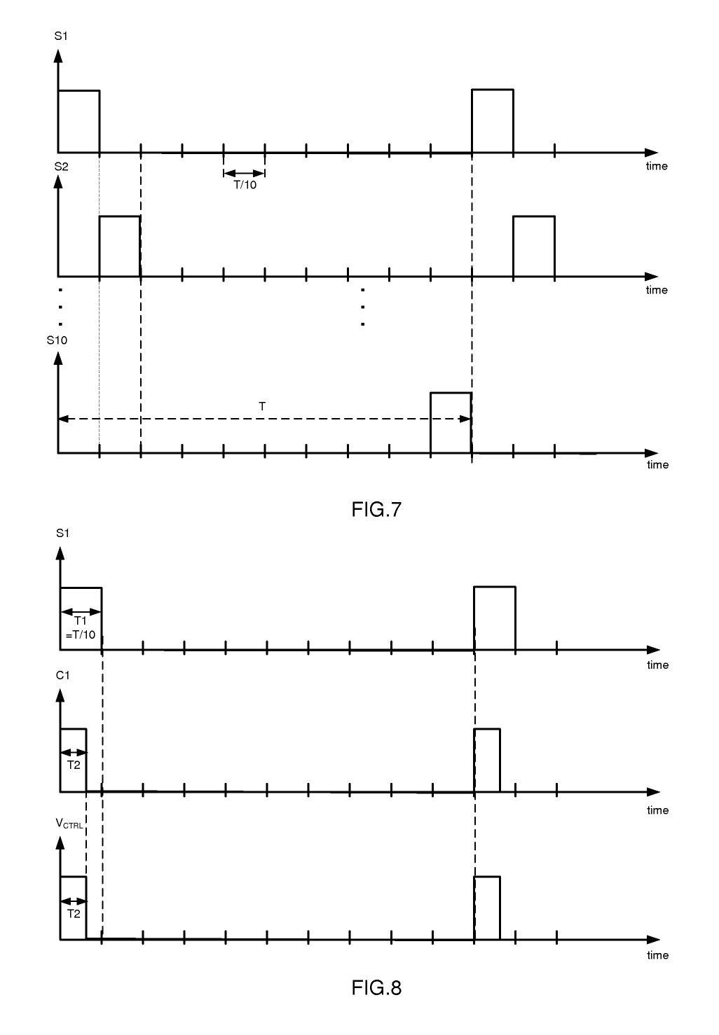

If the overall operation of the set 10 of FIG. 1 is now considered, the rows of basic blocks are selected sequentially as shown by the timing diagrams of FIG. 7. In this figure, it is considered that the set 10 comprises 10 rows of basic blocks. The selection circuit 11 thus comprises 10 outputs S1 to S10. The operating period T of the device is therefore divided into 10 sub-periods of equal time (T/10), a sub-period being assigned to each of the outputs S1 to S10.

FIG. 8 shows the signal V_{CTRL} applied at the block of the set 10 connected to the outputs S1 and C1 and the signals applied to these outputs. A pulse of time T1=T/10 is supplied on the output S1 as already shown in FIG. 7. This time is fixed and corresponds to the maximum time that can be applied to the block. A pulse of variable time T2 lower than or equal to T1 is applied to the output C1. The result is that the voltage V_{CTRL} applied at the block is a pulse of time T2 (identical to the one applied on the output C1). The time T2 defines the level of lighting required for the block considered and is between a minimum non-null time and the maximum time T1. The operating frequency 1/T is preferable greater than 20 KHz (namely T=50 μs) so that the sequential addressing is inaudible to the human ear. According to the number n of rows of blocks in the array 10 (the number is generally predefined), the maximum time T1 is linked with T through T1=T/n. Finally, so that the lighting is synchronised with the display of the images, the period of the video frame is preferably a multiple of the operating period (of time T) of the backlight device.

The inductance value L of the inductive element 34 is defined for the borderline case tₐ=T1 and is equal to:

$$L = \frac{1}{2} \cdot \frac{{V}_{a} - {V}_{LED}}{{I}_{max}} T 1.$$

It is possible to provide a particular embodiment wherein the complete discharge of the inductive element 34 finishes at the end of the period T, namely that t_{b}=T. It should be recalled that in a stable state, the average value at the terminals of the inductive element is equal to zero for a first approximation. It will be noted that in this case, the power transmitted to the LED is equal to

$$P = \frac{{V}_{LED} \cdot {I}_{max}}{2} .$$

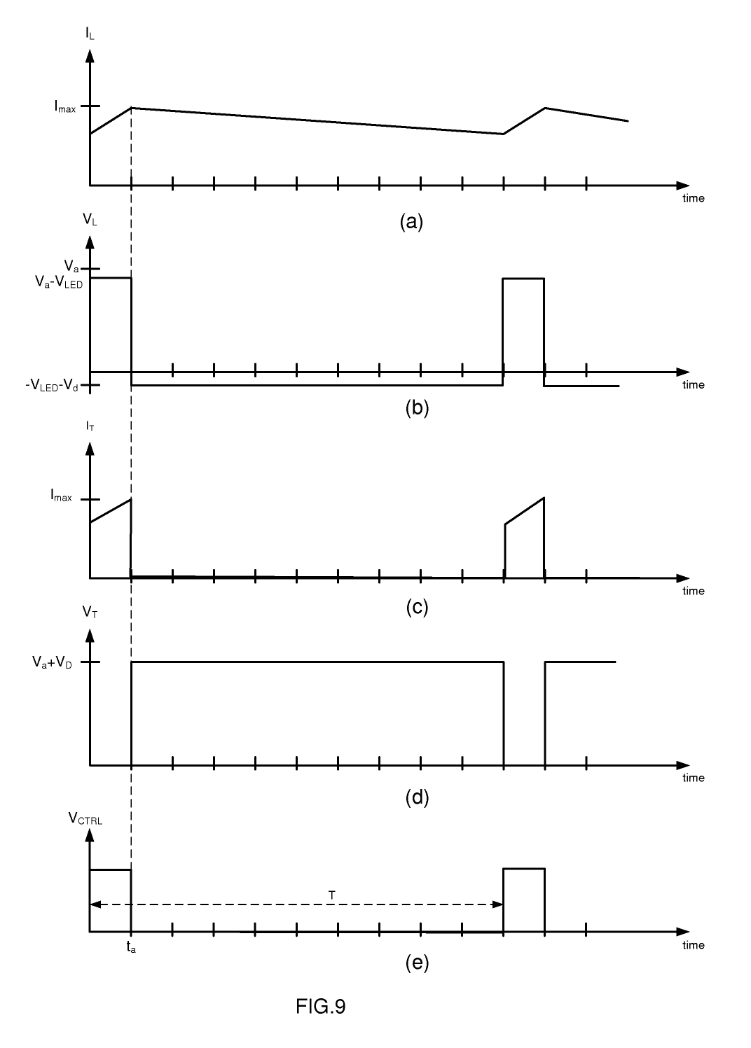

A second embodiment of the light emissive diode element shown in FIG. 3 is explained by the timing diagrams of FIG. 9. In this operating mode, the inductive element is not fully discharged at the end of the operating cycle. FIGS. 9(a), 9(b), 9(c), 9(d) and 9(e) respectively show the variation in the current I_{L}, the voltage V_{L}, the current I_{T}, the voltage V_{T} and the voltage V_{CTRL} during a period of time T of the control voltage V_{CTRL}.

These timing diagrams must be compared with those of FIG. 6. As shown in FIG. 9(a), the inductive element 34 charges when the switch 33 is closed (V_{T}=0) and discharges into LED 31 when it is open (voltage V_{T}=Vₐ+V_{D}). At the end of the cycle (time T), the current in the inductive element 34 is not zero. This embodiment enables the power transmitted to the LED 31 to be increased without increasing the conduction time of the switch 33.

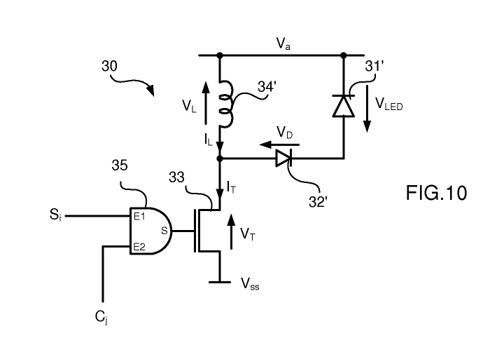

FIG. 10 shows a circuit diagram of a second example of a light emissive diode element 30. The first example illustrated by FIG. 3 is an electrical assembly wherein the anodes of the LEDs of the set 10 are connected in common (to the row receiving the voltage Vₐ). This second embodiment is a variant in which the cathodes of the LEDs of the set 10 are connected in common. This assembly comprises the same components as those of FIG. 3 but some of them are placed differently. The components whose position remains unchanged with respect to FIG. 3 keep the same numerical reference as in FIG. 3.

This assembly comprises a light emissive diode or LED 31′ and a step-down voltage converter to supply the LED. This converter comprises an inductive element 34′ fitted in series with a switch 33 of the transistor type between a supply terminal receiving the supply voltage Va (known as the supply terminal) and a terminal receiving the voltage Vss. The latter terminal is for example connected to ground. The transistor 33 is controlled by a control voltage supplied by an AND logic gate 35, the said gate receives on an input a voltage signal coming from the output Si of the selection circuit 11 and a voltage signal coming from the output Cj of the control circuit 12. The point located between the inductive element 34′ and transistor 33 is connected to the anode of the LED′ 31 via a diode 32′. The diode 32′ is arranged to pass the current moving toward the LED 31′. The cathode of the LED 31′ is connected to the supply terminal.

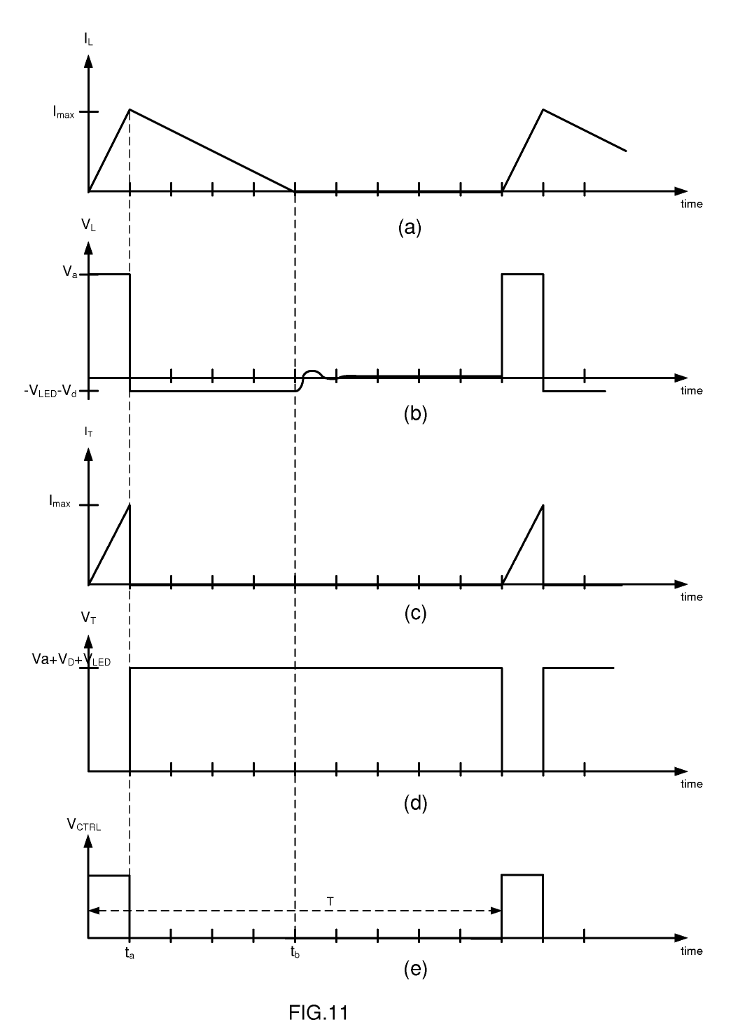

This assembly operates globally in the same manner as the assembly of FIG. 3, namely that the inductive element 34′ charges when the switch 33 is closed and discharges when it is open. However, the currents and voltages at the terminals of the components are a little different. An operating mode with complete discharge of the inductive element 34′ is shown in FIG. 11. FIGS. 11(a), 11(b), 11(c), 11(d) and 11(e) respectively show the variation in the current I_{L}, the voltage V_{L}, the current I_{T}, the voltage V_{T} and the voltage V_{CTRL} during a period of time T of the control voltage V_{CTRL}.

In the timing diagrams, it is considered that the control voltage V_{CTRL} is at a high level between the times 0 and tₐ and at a low level (zero) between the times tₐ and T. The switch 33 is therefore closed (voltage V_{T} zero) between the times 0 and tₐ and open (voltage V_{T}=Vₐ+V_{D}+V_{LED}) between the times tₐ and T. The voltage V_{L} at the terminal of the inductive element 34 is therefore equal to Vₐ between the times 0 and tₐ. A current I_{L} flows through the element 34′, said current increasing in a linear manner until a maximum value Iₘₐₓ equal to

$$\frac{1}{2} \cdot \frac{{V}_{a}}{L} {t}_{a}$$

at time tₐ is reached. The current I_{T} flowing through the switch 33 is therefore equal to the current I_{L} flowing through the inductive element 34′. When the switch 33 is open (between the times tₐ and T), the voltage V_{L} applied to the terminals of the inductive element 34′ is equal to −V_{LED}−V_{D} until this latter is fully discharged. The discharge operation is complete at time t_{b}. The discharge current of the element 34′ thus decreases until a zero value is reached at time t_{b}. The same operating cycle starts again at the end of the time T.

Naturally, the invention is not limited to the embodiments previously described.

In particular, those skilled in the art will be able to implement a set 10 wherein the blocks are selected by columns (and not rows). A pulse of maximum time is transmitted to the blocks of the column to select and a pulse of variable time is transmitted on the rows of blocks to modulate this time. Moreover, the blocks can have different sizes.

1. (canceled)

2. (canceled)

3) Backlight device for display, wherein it comprises:
a set of light emissive diode elements organised in rows and columns, each element comprising a light emissive diode and at least one element equipped with a step-down voltage converter to supply the said light emissive diode, and
a control circuit to control the voltage converter circuit of the said at least one light emissive diode, the control circuit comprising:
a selection circuit to sequentially select the rows of elements of the said set, and
a control circuit to trigger and control the time of the first operating phase of the elements of the row selected by the said selection circuit.

4) Device according to claim 3, wherein the voltage converter circuit comprises an inductive element and a switch, the said switch being controlled such that the said inductive element stores the energy during a first operating phase and discharges said energy into the said light emissive diode during a second operating phase consecutive to the said first operating phase.

5. (canceled)

6) Device according to claim 3, wherein the light emissive diode elements are divided into basic blocks, each basic block comprising at least one light emissive diode, the selection circuit sequentially selects the rows of basic blocks and the control circuit triggers and controls the time of the first operating phase of the elements of the blocks selected by the selection circuit.

7) Device according to claim 6, wherein the first operating phases of the elements of two basic blocks belonging respectively to one row of current blocks and one row of next blocks are not covering.

8) Device according to claim 7, wherein for each element, the time of the first operating phase is variable.

9) Device according to claim 8, wherein the time of the first operating phase is comprised between a minimum time and a maximum time.

10) Device according to claim 9, wherein the first operating phase of the blocks of the next row begins at the end of a period equal to the said maximum time after the start of the first operating phase of the blocks of the current row.

11) Display comprising a backlight device to produce light and an imaging device lit by the light produced by the backlight device to display an image during a video frame and wherein the backlight device is in accordance with the backlight device according to claim 3.

12) Display according to claim 11, wherein the operating period of the backlight device comprising the said first and second operating phases is synchronised with the video frame period.

13) Display according to claim 12, wherein the period of the video frame is a multiple of the time (T) of the operating period of the backlight device.

14) Display according to claim 13, wherein the time of the operating period of the backlight device is less than 50 μs.
